(19) United States
(12) Patent Application Publication
(10) Pub. No.: US 2020/0342291 A1
(43) Pub. Date: Oct. 29, 2020

(54) NEURAL NETWORK PROCESSING

(71) Applicants: Apical Limited, Cambridge (GB); Arm Limited, Cambridge (GB)

(72) Inventors: Daren CROXFORD, Swaffham Prior (GB); Roberto LOPEZ MENDEZ, Cambridge (GB)

(21) Appl. No.: 16/392,366

(22) Filed: Apr. 23, 2019

(51) Int. Cl. G06N 3/04; G06T 7/50; G06F 9/50

(52) U.S. Cl. CPC G06N 3/0454; G06F 9/5055; G06T 7/50

(57) ABSTRACT

A method of processing sensor-originated data using a computing device. The sensor-originated data is representative of one or more physical quantities measured by one or more sensors. The method comprises selecting between a plurality of neural networks, including a first neural network and a second neural network, on the basis of at least one current operative condition of the computing device. Each of the first and second neural networks is configured to generate output data of the same type. The first neural network is configured to receive a first set of input data types and the second neural network is configured to receive a second set of input data types, the second set including at least one data type not included in the first set. The method comprises processing the sensor-originated data using at least the selected neural network.

### BACKGROUND OF THE INVENTION

### Technical Field

The present disclosure relates to methods and apparatus for processing data with a neural network system.

### Background

Processing sensor-originated data, such as image data or audio data, with a neural network, e.g. to detect characteristics of the data such as features or objects in the image or audio, may be computationally intensive. It is therefore desirable to improve the computational efficiency of neural network systems and associated data processing methods.

### SUMMARY

According to a first embodiment, there is provided a method of processing sensor-originated data using a computing device, the sensor-originated data representative of one or more physical quantities measured by one or more sensors, and the method comprising:

selecting between a plurality of neural networks, including a first neural network and a second neural network, on the basis of at least one current operative condition of the computing device;

processing the sensor-originated data using at least the selected neural network, wherein:

each of the first and second neural networks is configured to generate output data of the same type; and

the first neural network is configured to receive a first set of input data types and the second neural network is configured to receive a second set of input data types, the second set including at least one data type not included in the first set.

According to a second embodiment, there is provided a computing device comprising:

at least one processor;

storage accessible by the at least one processor, the storage configured to store sensor-originated data representative of one or more physical quantities measured by one or more sensors;

wherein the at least one processor is configured to implement a plurality of neural networks including a first neural network and a second neural network configured to generate output data of the same type,

wherein the first neural network is configured to receive a first set of input data types and the second neural network is configured to receive a second set of input data types, the second set including at least one data type not included in the first set; and

a controller configured to:
select between the plurality of neural networks on the basis of at least one current operative condition of the computing device; and
process the sensor-originated data using at least the selected neural network.

Further features and advantages will become apparent from the following description which is made with reference to the accompanying drawings.

### BRIEF DESCRIPTION OF THE DRAWINGS

FIG. 1 schematically shows a neural network according to examples.

FIGS. 2A and 2B schematically show pluralities of neural networks, according to examples.

FIG. 3 schematically shows an example data processing system for use with the methods described herein.

### DETAILED DESCRIPTION OF CERTAIN INVENTIVE EMBODIMENTS

Details of systems and methods according to examples will become apparent from the following description, with reference to the Figures. In this description, for the purpose of explanation, numerous specific details of certain examples are set forth. Reference in the specification to “an example” or similar language means that a particular feature, structure, or characteristic described in connection with the example is included in at least that one example, but not necessarily in other examples. It should further be noted that certain examples are described schematically with certain features omitted and/or necessarily simplified for ease of explanation and understanding of the concepts underlying the examples.

A neural network typically includes several interconnected nodes, which may be referred to as artificial neurons, or neurons. The internal state of a neuron (sometimes referred to as an “activation” of the neuron) typically depends on an input received by the neuron. The output of the neuron may then depend on the input, a weight, a bias and an activation function. The output of some neurons is connected to the input of other neurons, forming a directed, weighted graph in which vertices (corresponding to neurons) or edges (corresponding to connections) of the graph are associated with weights, respectively. The neurons may be arranged in layers such that information may flow from a given neuron in one layer to one or more neurons in a successive layer of the neural network. Examples include an object classifier executing in a neural network accelerator.

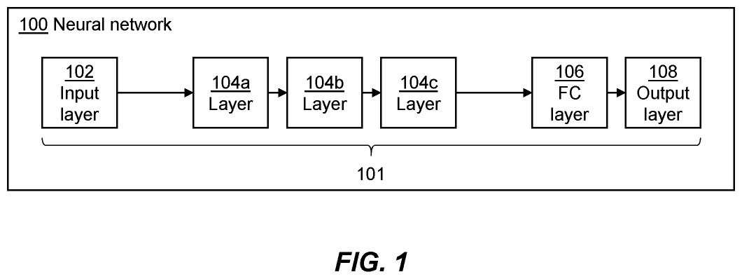

FIG. 1 schematically shows a neural network 100 according to examples. The neural network 100 comprises a plurality of layers 101. In FIG. 1, the neural network 100 is a convolutional neural network (CNN). In other examples, the neural network 100 may be a different kind of neural network. An example of a CNN is the VGG-16 CNN, although other CNNs may be used instead. A typical CNN includes an input layer 102, a plurality of convolutional layers (three of which, 104a, 104b, 104c, are shown in FIG. 1), at least one fully connected layer 106, and an output layer 108. In some cases, however, a CNN may not have a fully connected layer 106.

The input layer 102 for example corresponds with an input to the neural network 100, which may be sensor-originated data such as image data, video data, and/or audio data. In this example, the input is image data. The image data is, for example, 224 pixels wide and 224 pixels high and includes 3 color channels (such as a red, green and blue color channel forming RGB data). In other examples, the image data may have different dimensions and/or different color channels (e.g. cyan, magenta, yellow, and black channels forming CMYK data; or luminance and chrominance channels forming YUV data).

The convolutional layers 104a, 104b, 104c typically extract particular features from the input data, to create feature maps. The at least one fully connected layer 106 can then use the feature maps for further processing, e.g. object classification. The fully connected layer(s) may execute object definitions, in the form of object classes, to detect the presence of objects conforming to the object classes in the image data. In FIG. 1, the neural network 100 includes solely one fully connected layer 106. However, in other examples, the neural network 100 may include a plurality of fully connected layers, with an output of one of the fully connected layers being received as an input by a subsequent fully connected layer.

In some cases, the output of one convolutional layer 104a undergoes pooling before it is input to the next layer 104b. Pooling for example allows values for a region of an image or a feature map to be aggregated or combined, for example by taking the highest value within a region. For example, with “2×2 max” pooling, the highest value of the output of the layer 104a within a 2×2 patch of the feature map output from the layer 104a is used as an input to the 104b, rather than transferring the entire output of the layer 104a to the layer 104b. This reduces the amount of computation for subsequent layers of the neural network 100. Further pooling may be performed between other layers of the neural network 100. Conversely, pooling may be omitted in some cases. It is to be appreciated that the neural network 100 has been greatly simplified for ease of illustration and that typical neural networks may be significantly more complex.

In general, neural network systems such as the neural network 100 of FIG. 1 may undergo what is referred to as a “training phase”, in which the neural network is trained for a particular purpose. As described, a neural network typically includes several interconnected neurons forming a directed, weighted graph in which vertices (corresponding to neurons) or edges (corresponding to connections) of the graph are associated with weights, respectively. The weights may be adjusted throughout training, altering the output of individual neurons and hence of the neural network as a whole. In a CNN, a fully connected layer 106 typically connects every neuron in one layer to every neuron in another layer and may therefore be used to identify overall characteristics of an input, such as whether the input (e.g. an image) includes an object of a particular class, or a particular instance belonging to the particular class, as part of an object classification process.

In the example of FIG. 1, the neural network 100 has been trained to perform object detection by processing input data comprising image data, for example to determine whether an object of a predetermined class of objects is present in the image represented by the image data (although in other examples the neural network 100 may have been trained to identify other image characteristics of the image instead). Training the neural network 100 in this way may generate one or more kernels associated with at least some of the layers (such as layers of the neural network 100 other than the input layer 102 and the output layer 108). Hence, the output of the training may be a plurality of kernels associated with a predetermined neural network architecture (for example with different kernels being associated with different respective layers of a multi-layer neural network architecture). The kernel data may be considered to correspond to weight data representative of weights to be applied to image data, as each element of a kernel may be considered to correspond to a weight, respectively. Each of these weights may be multiplied by a corresponding pixel value of an image patch, to convolve the kernel with the image patch as described below.

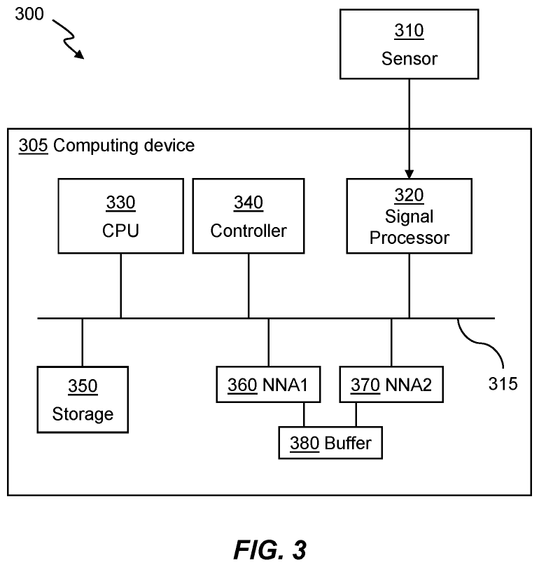

The kernels may allow features of the input to be identified. For example, in the case of image data, some of the kernels may be used to identify edges in the image represented by the image data and others may be used to identify horizontal or vertical features in the image (although this is not limiting, and other kernels are possible). The precise features that the kernels are trained to identify may depend on the image characteristics, such as the class of objects, that the neural network 100 is trained to detect. The kernels may be of any size. As an example, each kernel may be a 3×3 matrix of values, which may be convolved with the image data with a stride of 1. The kernels may be convolved with an image patch (or a feature map obtained by convolution of a kernel with an image patch) to identify the feature the kernel is designed to detect. Convolution generally involves multiplying each pixel of an image patch (in this example a 3×3 image patch), or each element of a feature map, by a weight in the kernel before adding the result of this operation to the result of the same operation applied to neighboring pixels or neighboring feature map elements. A stride, for example, refers to the number of pixels or feature map elements a kernel is moved by between each operation. A stride of 1 therefore indicates that, after calculating the convolution for a given 3×3 image patch, the kernel is slid across the image by 1 pixel and the convolution is calculated for a subsequent image patch. This process may be repeated until the kernel has been convolved with the entirety of the image (or the entire portion of the image for which a convolution is to be calculated), or with the entirety of a feature map the kernel is to be convolved with. A kernel may sometimes be referred to as a “filter kernel” or a “filter”. A convolution generally involves a multiplication operation and an addition operation, sometimes referred to as a multiply-accumulate (or “MAC”) operation. Thus, a neural network accelerator configured to implement a neural network, such as that of FIG. 3, may include a multiplier-accumulator (MAC) unit configured to perform these operations.

After the training phase, the neural network 100 (which may be referred to as a trained neural network 100) can be used to detect the presence of objects of a predetermined class of objects in input images. This process may be referred to as “classification” or “inference”. Classification typically involves convolution of the kernels obtained during the training phase with image patches of the image input to the neural network 100 to generate a feature map. The feature map may then be processed using at least one fully connected layer 106, e.g. to classify the image; although other types of processing may be performed on the feature map by the at least one fully connected layer 106. Neural networks 100 can be trained and used to perform other types of processing, e.g. image segmentation, in other examples.

In the example of FIG. 1, the layer 104a involves the convolution of 64 different kernels with the image data of the input layer 102. Each of the 64 kernels is, for example, arranged to identify a different respective feature of the image data. In an illustrative example in which the image data is 224×224 pixels in size, with 3 color channels, and is convolved with 64 kernels of a size of 3×3 pixels, the layer 104a of the neural network 100 involves 224×224×3×(3×3)×64 multiply-accumulate operations, i.e. 86 million MAC operations. There will also be many further multiply-accumulate operations associated with each of the further layers 104b, 104c, 106 of the neural network 100. As will be appreciated, though, other neural networks may involve convolutions with a different number of kernels, which may be of a different size. Nevertheless, processing an image to identify an image characteristic such as the presence of an object of a predetermined class, or a particular instance of the object, typically involves a large number of data processing operations, each of which consumes power.

In the example of FIG. 1, image data received by the input layer 102 of the neural network 100 is processed using layers 104a, 104b, 104c to generate feature data. The sensor-originated image data may represent at least one characteristic of the light captured by an image sensor, such as an intensity of the light captured by each sensor pixel, which may be proportional to the number of photons captured by that sensor pixel. The intensity may represent a luminance of the captured light, which is for example a measure of the intensity of light per unit area rather than an absolute intensity. In other examples, the image data may be representative of a brightness of captured light, which may be considered to correspond to a perception of a luminance, which may or may not be proportional to the luminance. In general, the image data may represent any photometric quantity or characteristic that may be used to represent the visual appearance of the image represented by the image data or may be derived from any such photometric quantity or characteristic. The image data may be in any suitable format, such as a raw image format. For example, the image data may be streamed from the image sensor, with or without being saved to a framebuffer, without saving the raw image data to memory. In such cases, image data obtained after processing of the raw image data may, however, be written to memory.

In this example, the layers 104a, 104b, 104c of the neural network 100 may be used to generate feature data representative of at least one feature of the image. The feature data may represent an output feature map, which may be output from a convolutional layer of a CNN such as the neural network 100 of FIG. 1. There may be more or fewer layers in the neural network 100 than those shown in FIG. 1. In examples in which the neural network 100 includes a plurality of layers 104a, 104b, 104c between the input layer 102 and the fully connected layer 106 and/or the output layer 108, as shown in FIG. 1, each of the said plurality of layers 104a, 104b, 104c may be used to generate intermediate feature data. The intermediate feature data may be representative of at least one feature of the input, e.g. the image. The intermediate feature data output from one of the layers (e.g. layer 104a) may be input to a subsequent layer of the neural network 100 (e.g. layer 104b) to identify further features of the image represented by the image data input to the neural network 100.

Although not shown in FIG. 1, it is to be appreciated that further processing may be applied to the sensor-originated (e.g. audio or image) data after it has been obtained by a sensor (e.g. an audio or image sensor) and before the sensor-originated data is processed by the layers of the neural network 100. Said further processing may be performed by other components of a data processing system or as part of the neural network 100 itself.

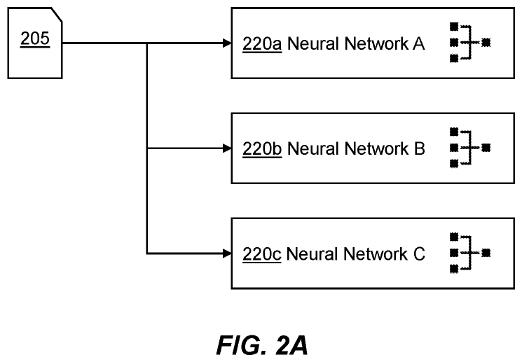

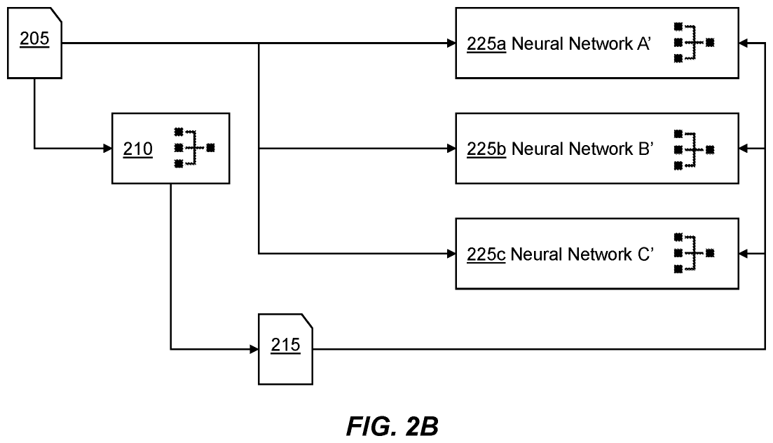

According to the present disclosure, and with reference to FIGS. 2A and 2B, there is provided a method of processing sensor-originated data using a computing device. The sensor-originated data is representative of one or more physical quantities measured by one or more sensors. For example, the sensor-originated data may comprise one or more of: image data representative of an image; video data representative of a video; audio data representative of a sound; depth data representative of depth in an environment; or another form of sensor-originated data representative of one or more different physical quantities.

The sensor-originated data may comprise one or more of image data, video data, and audio data, or another form of sensor-originated data. The sensor-originated data may be “source data”, or “raw data”, output directly from a sensor (e.g. sensor data). In such cases, the sensor-originated data may be obtained from the sensor, e.g. by direct transfer of the data or by reading the data from intermediate storage on which the data is stored. In other cases, the sensor-originated data may have been preprocessed: for example, further processing may be applied to the sensor-originated data after it has been obtained by the sensor and before it is processed using the computing device. In some examples, the sensor-originated data comprises a processed version of the sensor data output by the sensor. For example, the sensor data (or preprocessed version thereof) may have been subsequently processed to produce the sensor-originated data for processing at the computing device. In some cases, the sensor-originated data may comprise feature data representative of one or more features of the sensor-originated data. For example, the sensor-originated data may include image feature data representative of at least one feature of an image and/or audio feature data representative of at least one feature of a sound. Feature data may be representative of a feature map, e.g. which may have been outputted from a convolutional layer of a CNN like the neural network 100 of FIG. 1.

The method involves selecting between a plurality of neural networks, including a first neural network 220a and a second neural network 225a, on the basis of at least one current operative condition of the computing device, and processing the sensor-originated data using at least the selected neural network 220a, 225a. Such selection based on the at least one current operative condition of the computing device allows the processing of the sensor-originated data to be adaptable in response to variations in circumstances which impact the at least one current operative condition. For example, selecting between the plurality of neural networks in the ways described herein may allow for the computing device implementing the neural networks to operate more efficiently, e.g. to reduce processing, storage, and/or power requirements when implementing the plurality of neural networks.

Each of the first and second neural networks 220a, 225a is configured to generate output data of the same type. For example, both first and second neural networks 220a, 225a may be trained to perform facial recognition on image data and thus each configured to generate output data indicative of whether a human face, or a specific human face, is present in the input image. However, the first neural network is configured to receive a first set of input data types while the second neural network is configured to receive a second set of input data types, with the second set including at least one data type that is not included in the first set. In the example of FIGS. 2A and 2B, the first facial recognition neural network (neural network A) 220a is configured to receive a first set of input data types including RGB data 205. The second facial recognition neural network (neural network A′) 225a is configured to receive a second set of input data types, which also includes RGB data 205, but additionally includes depth data 215 which is not included in the first set of input data types fed to neural network A.

The depth data may represent a depth map, for example, comprising pixel values which represent depth-related information, such as a distance from the depth sensor. The depth data may be calibrated with the image data (e.g. RGB data). For example, pixel values in the depth map may correspond to those in the image data. The depth map may be of a same size and/or resolution as the image frames, for example. In other cases, however, the depth map may have a different resolution to the image data.

In another example, the first and second neural networks 220a, 225a may both be configured to perform speech recognition based on input audio data, and thus each configured to generate word output data, e.g. in text format. The first speech recognition neural network (neural network A) 220a may be configured to receive a first set of input data types including the original audio data 205 while the second speech recognition neural network (neural network A′) 225a is configured to receive a second set of input data types which includes denoised audio data 215 (e.g. a denoised version of the original audio data 205) not included in the first set of input data types fed to neural network A.

The at least one data type, included in the second set but not the first set of data types, may comprise sensor data obtained from a sensor. For example, in the example above where the first and second neural networks 220a, 225a are configured to process image data types and the said at least one data type comprises depth data, the depth data may be captured by a depth sensor such as a time-of-flight camera or stereo camera. In other examples, the said at least one data type may be obtained via data processing of another data type. For example, the depth data 215 in FIG. 2B is outputted by an intermediate neural network 210 which receives the RGB data 205 as input and generates the depth data 215 based thereon. In some examples, the said at least one data type may be output from one or more intermediate neural networks 210 which receive sensor data as input.

In some examples, the sensor-originated data is processed using a set of neural networks comprising the selected neural network. For example, referring to FIG. 2B with neural network A′ 225a as the selected neural network, the sensor-originated data 205, 215 may be processed using a set of neural networks comprising the selected neural network A′ 225a and the intermediate neural network 210. In the example of FIG. 2B, the said set of neural networks also comprises neural networks B′ and C′ 225b, 225c. In an example, the sensor-originated data comprises RGB data 205 and depth data 215, and the set of neural networks additionally comprises a facial expression recognition neural network 225b and a gesture recognition neural network 225c.

In a different example, while referring to FIG. 2A with neural network A 220a as the selected neural network, the sensor-originated data 205 may be processed using a set of neural networks comprising the selected neural network A without an intermediate neural network 210. In this example, the said set of neural networks also comprises neural networks B and C 220b, 220c. Referring to the example in which the sensor-originated data comprises RGB data 205, neural network B may be a facial expression recognition neural network 220b and neural network C may be a gesture recognition neural network 220c. The neural networks B and C in the set of neural networks comprising the first neural network A, shown in FIG. 2A, may correspond to the neural networks B′ and C′ in the set of neural networks comprising the second neural network A′, shown in FIG. 2B, in that they are respectively trained to perform corresponding functions and/or output data of the same type or kind. For example, neural networks B and B′ may both be configured to perform facial expression recognition, and networks C and C′ may both be configured to perform gesture recognition. Neural networks B′ and C′ in this example are configured to receive a data type which neural networks B and C are not, namely depth data. Neural networks B and C may be trained on RGB data 205, whereas neural networks B′ and C′ may be trained on RGB data 205 and depth data 215, for example.

In examples, the set of neural networks which comprise the selected neural network may include a plurality of neural networks connected such that an output of one neural network in the set forms an input for another neural network in the set. For example, referring to FIG. 2B with the second neural network 225a as the selected neural network, the said set of neural networks includes a plurality of neural networks 210, 225a, 225b, 225c, connected such that an output of the intermediate neural network 210, e.g. depth data 215, forms an input for another neural network in the set, e.g. each of the neural networks A′ to C′ in the example shown in FIG. 2B. The set of neural networks may comprise a sequence of neural networks 210, 225a including the selected neural network 225a, for example.

As described herein, selecting between the plurality of neural networks is based on at least one operative condition of the computing device used to process the sensor-originated data. In examples, the at least one operative condition comprises an estimated latency of processing the sensor-originated data by the selected one of the plurality of neural networks. For example, the latency may correspond to a time delay between the selected neural network receiving its input, e.g. RGB image data and depth data, and generating its output data, e.g. facial recognition data indicative of whether a given image includes a face. The latency of outputs by the selected neural network system may be monitored, e.g. to determine a set of latency values. In such examples, the latency may correspond to a time delay between successive outputs of data by the selected neural network. In examples, selecting between the plurality of neural networks is based on an indication that a value representative of the estimated latency has a predetermined relationship with a comparative latency value. For example, the estimated latency of processing RGB data 205 with the first neural network 220a may be compared with a comparative latency value, e.g. a threshold value. If the estimated latency has the predetermined relationship with, e.g. is less than, the comparative latency value, the first neural network 220a may be selected to process the RGB data 205. In certain cases, the comparative latency value is representative of a latency of processing the sensor-originated data by a different one of the plurality of neural networks. For example, if the estimated latency of processing the RGB data 205 with the first neural network 220a is determined to be less than the estimated latency of processing the RGB data 205 and depth data 215 with the second neural network 225a, the first neural network 220a may be selected to process the RGB data 205.

In some examples, the at least one operative condition comprises an estimated energy usage of processing the sensor-originated data using at least the selected one of the plurality of neural networks. The energy usage may correspond to how much energy is used by the computing device to perform the processing, e.g. relative to a maximum energy usage available. For example, the plurality of neural network systems including the first and second neural networks 220a, 225a may be implemented by at least one processor (described in more detail below with reference to FIG. 3). The at least one processor may have access to storage (described in more detail below with reference to FIG. 3) to perform its processing. The estimated energy usage of processing the sensor-originated data using a given neural network may be related to, e.g. based on, an estimated processor usage of processing the sensor-originated data using the given neural network. The processor usage may correspond to how much the at least one processor is working, e.g. relative to a capacity of the at least one processor. Additionally or alternatively, the estimated energy usage of processing the sensor-originated data using a given neural network may be related to, e.g. based on, an estimated bandwidth usage for processing the sensor-originated data using the given neural network. The bandwidth usage may correspond to how much bandwidth is used by the at least one processor to perform the processing, e.g. relative to a maximum bandwidth available. The bandwidth usage may include a usage of storage bandwidth, by the at least one processor, for internal and/or external storage accesses.

In an example, the estimated energy usage of processing RGB data 205 using at least the first neural network 220a may be compared with a comparative energy usage value, e.g. a threshold value. If the estimated energy usage has a predetermined relationship with, e.g. is less than, the comparative energy usage value, the first neural network 220a may be selected to process the RGB data 205. In certain cases, the comparative processor energy value is representative of an energy usage of processing the sensor-originated data by a different one of the plurality of neural networks.

In described examples, processing the sensor-originated data comprises processing the sensor-originated data using a set of neural networks including the selected neural network. In such cases, the operative condition of the computing device may be an estimated energy usage to process the sensor-originated data using the set of neural networks comprising the selected neural network. The controller may thus be configured to select between the neural networks based on an indication that a value representative of the estimated energy usage has a predetermined relationship with, e.g. is less than, a comparative energy usage value. The comparative energy usage value may be representative of an estimated energy usage to process the sensor-originated data using a different set of neural networks to the set of neural networks including the selected neural network. As described, the estimated energy usage may be related to, e.g. based on, a corresponding processor usage and/or bandwidth usage.

In examples, the at least one operative condition of the computing device comprises an availability of at least one system resource of the computing device. Examples of the availability of the at least one system resource include: a state of charge of an electric battery configured to power the computing device; an amount of available storage accessible by the computing device; an amount of processor usage available to the computing device; an amount of energy usage available to the computing device; and an amount of bandwidth available to at least one processor configured to implement at least one of the first and second neural networks. For example, the selecting between the plurality of neural networks 220a, 225a may be based on estimated energy usages, as described, as well as the amount of energy usage available to the computing device. The energy usage available may be based on an amount of electrical power available to the computing device, for example. As an example involving processor usage, if the estimated processor usage to process the sensor-originated data using one of the first and second neural networks 220a, 225a (or a set of neural networks comprising the first or second neural network 220a, 225a) exceeds a limit set in accordance with the amount of processor usage available to the computing device, for example, that neural network (or set of neural networks) may be less likely to be selected to process the sensor-originated data.

In examples, the at least one operative condition of the computing device comprises an availability of one or more given data types. For example, selecting between the neural networks may be done based one which data types are available to feed to the respective neural networks. In the examples described above where the first and second neural networks 220a, 225a are each trained for facial recognition, with the first neural network 220a configured to receive RGB data 205 and the second neural network 225a configured to receive RGB data 205 and depth data 215, the selecting may be based on whether the given data types of RGB data and depth data are available. For example, if depth data is not available (e.g. from a depth sensor) using at least the second neural network 225a to process the sensor-originated data may be less likely. However, in examples, this may be compensated by the estimated latency and/or processor usage associated with using the intermediate neural network 210 (to generate depth data 215 based on the available RGB data 205) and the second neural network 225a to process the sensor-originated data being less than that of using the first neural network 220a without depth data. The at least one operative condition of the computing device may thus comprise, in examples, an indication that the set of neural networks containing the neural network to be selected can be utilized based on an availability of one or more given data types required by that set of neural networks.

The availability of one or more data types (e.g. for feeding to different neural networks) may comprise an indication of whether previously generated data (e.g. output from an intermediate neural network) of a given data type is “stale”. Such an indication of stale data may be based on one or more factors, e.g. how long ago the data was generated, and/or characteristics of the sensor-originated data. For example, if a scene represented in image data (as the sensor-originated data) is changing more quickly, a time threshold for determining whether data generated based on the said image data may be lower than if the scene is changing less quickly. The time threshold may be a time value wherein if previously generated data was generated longer ago than the time threshold, the data is determined to be stale and vice versa. If previously generated data is determined to not be stale, the data may be usable and thus indicated as an available data type, for example.

In some cases, the first neural network may be selected and thus used to process the sensor-originated data before an indication that the at least one data type not included in the first set is available for the processing is obtained. Based on this indication, subsequent processing of sensor-originated data may be switched to using at least the second neural network. For example, the facial recognition neural network A of FIG. 2A may be selected to process the sensor-originated RGB data 205, e.g. based on an availability (or specifically a lack thereof) of depth data to feed to the facial recognition neural network A′ of FIG. 2B. An indication may be subsequently obtained that indicates that depth data has become available, e.g. has become obtainable from a depth sensor or from another neural network which, like the intermediate neural network 210, is configured to generate depth data based on image data. Based on this indication, subsequent processing of sensor-originated data may be switched to using the intermediate neural network 210 and the facial recognition neural network A′ of FIG. 2B, e.g. in lieu of the prior selected facial recognition neural network A.

In some examples, once a given neural network is selected to process the sensor-originated data, the selection is fixed e.g. for a predetermined time period and/or until an indication to reselect a neural network from the plurality of neural networks is received. Fixing the selection may be based on the processing being performed, e.g. if a specific application is being implemented by the at least one neural network, like face recognition and/or gesture recognition.

In alternative examples, the selection of a neural network from the plurality of the neural networks may not be fixed over a time period and thus may update frequently, e.g. based on availability of data types as described. For example, if the depth data 215 is generated by the intermediate neural network 210 at a lower frequency than image processing is performed by the neural networks A′ to C′ or A to C (e.g. 20 times per second and 40 times per second, respectively) the set of neural networks shown in FIG. 2A may be selected to process an initial image frame, and then the set of neural networks shown in FIG. 2B may be selected to process the subsequent image frame based on the availability of the depth data being dependent on the output frequency of the intermediate neural network 210.

An example of a data processing system 300 for use with the methods described herein is shown schematically in FIG. 3. The data processing system 300 of FIG. 3 comprises a computing device 305, such as a personal computer, a laptop, a smartphone or an on-board computer device which may be coupled to or mounted within a vehicle.

The data processing system 300 of FIG. 3 also includes a sensor 310. The sensor 310 may capture sensor data representative of a physical quantity it is configured to detect. For example, the sensor 310 may comprise one or more of an audio sensor configured to capture audio, and an image sensor configured to capture images. An image sensor typically includes an array of sensor pixels, which may be any suitable photosensors for capturing images. For example, a typical sensor pixel includes a photosensitive element such as a photodiode that can convert incident light into electronic signals or data. The sensor pixel may for example be a charge-coupled device (CCD) or a complementary metal-oxide-semiconductor (CMOS). The image sensor may be arranged to capture image data representative of an image. The image may form part of a video, which is typically a series of images captured sequentially. For example, the image may correspond to a frame of a video.

In FIG. 3, the sensor 310 is arranged to transfer captured data to a signal processor 320 of the computing device 305. The signal processor 320 may comprise a digital signal processor (DSP), a codec (e.g. an audio or video codec), or another type of processor configured to process signals or signal data. In examples where the sensor 310 comprises an image sensor, the signal processor 320 may comprise an image signal processor (ISP). The image sensor may be arranged to transfer captured image data to the ISP via a camera serial interface (CSI). The signal processor 320 may perform initial processing of the captured data to prepare the data for further processing or use. For example, the signal processor 320 comprising an ISP may perform saturation correction, renormalization, white balance adjustment and/or de-mosaicing on the captured image data, although this is not to be taken as limiting.

The computing device 305 of FIG. 3 includes at least one processor. In this example, computing device 305 includes a central processor unit (CPU) 330. The computing device 305 also includes at least one neural network accelerator which is, for example, a processor dedicated to implementing a neural network. For example, a neural network accelerator may be a processor dedicated to implementing classification of data using a neural network. The at least one neural network accelerator is configured to implement first and second neural networks such as those described above. In examples, the at least one neural network accelerator is a neural network accelerator (such as a single or sole neural network accelerator) that is configured to implement both the first and second neural networks. However, in the example of FIG. 3, the at least one neural network includes a first neural network accelerator (NNA1) 360 and a second neural network accelerator (NNA2) 370. The first neural network accelerator 360 may be configured to implement a first neural network 100 such as that described above, and the second neural network accelerator 370 may be configured to implement a second neural network 200 such as that described above.

In other examples, though, the computing device 305 may include other or alternative processors such as a microprocessor, a general purpose processor, a further DSP, an application specific integrated circuit (ASIC), a field programmable gate array (FPGA) or other programmable logic device, a discrete gate or transistor logic, discrete hardware components, or any suitable combination thereof designed to perform the functions described herein. The data processing system 300 may additionally or alternatively include a processor implemented as a combination of computing devices, e.g., a combination of a DSP and a microprocessor, a plurality of microprocessors, one or more microprocessors in conjunction with a DSP core, or any other such configuration. The computing device 305 may also or alternatively include at least one graphics processing unit (GPU). The first and/or second neural network 100, 200 may be implemented by one or more of these other processors in examples.

The computing device 305 of FIG. 3 includes a controller 340. In accordance with the methods described herein, the controller 340 is configured to select between the plurality of neural networks on the basis of at least one current operative condition of the computing device 305. The controller 340 is also configured to process the sensor-originated data using at least the selected neural network. In examples, the controller 340 is configured to process the sensor-originated data using a set of neural networks comprising the selected neural network; as described with reference to FIGS. 2A and 2B.

Examples of the at least one current operative condition of the computing device 305 have been described above. In one example, the operative condition of the computing device 305 comprises an estimated processor usage, of the at least one processor configured to implement the plurality of neural networks (e.g. neural network accelerators 360, 370), to process the sensor-originated data using a set of neural networks comprising the selected neural network. The controller 340 may be configured accordingly to select between the neural networks based on an indication that a value representative of the estimated processor usage has a predetermined relationship with a comparative processor usage value. For example, the comparative processor usage value may be representative of an estimated processor usage, of the at least one processor 360, 370, to process the sensor-originated data using a different set of neural networks.

The controller 340 may comprise hardware and/or software to control or configure the neural networks 100, 200. For example, the controller 340 may be implemented at least in part by computer software stored in (non-transitory) memory and executable by the processor. Alternatively, the controller 340 may be implemented at least in part by hardware, or by a combination of tangibly stored software and hardware (and tangibly stored firmware). In some examples, the controller 340 includes a processor and a memory. Computer executable code that includes instructions for performing various operations of the controller 340 described herein can be stored in the memory. For example, the functionality for controlling or interacting with the plurality of neural networks 100, 200 can be implemented as executable neural network control code stored in the memory and executed by the processor. As such, the executable code stored in the memory can include instructions for operations that when executed by processor cause the processor to implement the functionality described in reference to the example controller 340.

In other examples, the controller 340 may additionally or alternatively comprise a driver as part of the CPU 330. The driver may provide an interface between software configured to control or configure the neural networks and the at least one neural network accelerator which is configured to perform the processing to implement the neural networks. In other examples, though, a neural network may be implemented using a more general processor, such as the CPU or a GPU, as explained above.

The computing device 305 of FIG. 3 also includes storage 350 configured to store the sensor-originated data, which is accessible by the at least one processor configured to implement the plurality of neural networks. The storage 350 is, for example, external to the neural network accelerator(s) 360, 370. The storage 350 may be a random-access memory (RAM) such as DDR-SDRAM (double data rate synchronous dynamic random-access memory). In other examples, the storage 350 may be or include a non-volatile memory such as Read Only Memory (ROM) or a solid-state drive (SSD) such as Flash memory. The storage 350 in examples may include further storage devices, for example magnetic, optical or tape media, compact disc (CD), digital versatile disc (DVD) or other data storage media. The storage 350 may be removable or non-removable from the computing device 305. The storage 350 is for example arranged to store sensor-originated data, e.g. image data representative of at least part of an image, which may be received from the DSP 320. In some examples, the computing device 305 of FIG. 3 also includes a dynamic memory controller (DMC) which may be used to control access to the storage 350 of the data processing system 305.

In addition to the storage 350, which may be system storage or a main memory, the computing device 305 of FIG. 3 includes further storage (in this example a buffer 380 e.g. comprising cache storage) which is accessible to the at least one processor configured to implement the plurality of neural networks, in this case to the first and second neural network accelerators 360, 370. For example, the first and second neural network accelerators 360, 370 may each be configured to read and write feature data and/or weight data (as described above) to the buffer 380. Additionally, or alternatively, each neural network accelerator 360, 370 may comprise and/or have access to its own storage, e.g. a respective buffer 380.

In the example of FIG. 3, the computing device 305 includes a neural network accelerator system comprising the first neural network accelerator 360 and the second neural network accelerator 370. In such examples, the buffer 380 may be a local storage of the neural network accelerator system, which is accessible to the first and second neural network accelerators 360, 370. For example, the neural network accelerator system including the first and second neural network accelerators 360, 370 may be implemented in hardware, for example on a chip, and the buffer 380 may be on-chip memory. The buffer 380 may be a static random-access memory (SRAM), for example, although other memory types are possible. In examples, the buffer 380 may be used to store weight data representative of weights corresponding to respective neurons in the different layers of the plurality of the neural networks. Thus, in examples described above in which one or more layers serve more than one neural network, e.g. the first and second neural networks, more weights may be stored in the buffer 380 (or whichever storage is used to store weight data) using the same amount of weight data than implementing the more than one neural network independently. Similarly, the superset of weights associated with the merged layer 103 may be stored together in the buffer 380. The buffer 380 may also store biases, control data, input data (e.g. input feature maps), output feature maps, and/or output data (e.g. results)

In other examples, the computing device 305 may not include such a buffer 380. In such cases, the first and second neural network accelerators 360, 370 may each be configured to read and write feature data and/or weight data (described above) to the storage 350, which is for example a main memory.

In other examples, in which a neural network accelerator is configured to implement both the first and second neural networks, the neural network accelerator may include local storage, similarly to the first and second neural network accelerators 360, 370 described with reference to FIG. 3. In such cases, the neural network accelerator may be configured to read and write feature data to the local storage. The local storage may be like the buffer 380 of FIG. 3, and the corresponding description thereof applies here also.

The components of the data processing system 300 in the example of FIG. 3 are interconnected on the computing device 305 using a systems bus 315. This allows data to be transferred between the various components. The bus 315 may be, or include, any suitable interface or bus. For example, an ARM® Advanced Microcontroller Bus Architecture (AMBA®) interface, such as the Advanced eXtensible Interface (AXI), may be used.

The above examples are to be understood as illustrative examples. Further examples are envisaged. For example, although in examples described above the first and second neural networks are each CNNs, in other examples other types of neural network may be used as the first and/or second neural networks. Furthermore, although in many examples described above, the first and second neural networks are configured to process image data, in other cases another form of sensor-originated data, e.g. audio data, is processable by the first and second neural networks in a corresponding way. As described, in some examples the sensor-originated data may be sensor data output by a sensor (e.g. the raw image or audio data), which may be obtained directly from the sensor or via intermediate storage. In other examples, as described herein, the sensor-originated data may comprise a processed version of the original sensor data output by the sensor, e.g. it may be feature data output by a neural network, which may be obtained directly from the neural network or via intermediate storage. In other words, the sensor-originated data originates from data, representative of a physical quantity, as captured by a sensor; the captured sensor data may have subsequently been processed so that the sensor-originated data, received as input at the merged layer, is derived from the original captured sensor data).

It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

What is claimed is:

1. A method of processing sensor-originated data using a computing device, the sensor-originated data representative of one or more physical quantities measured by one or more sensors, and the method comprising:
selecting between a plurality of neural networks, including a first neural network and a second neural network, on the basis of at least one current operative condition of the computing device;
processing the sensor-originated data using at least the selected neural network, wherein:
each of the first and second neural networks is configured to generate output data of the same type; and
the first neural network is configured to receive a first set of input data types and the second neural network is configured to receive a second set of input data types, the second set including at least one data type not included in the first set.

2. The method according to claim 1, wherein processing the sensor-originated data comprises processing the sensor-originated data using a set of neural networks comprising the selected neural network.

3. The method according to claim 2, wherein the set of neural networks comprises a plurality of neural networks connected such that an output of one neural network in the set forms an input for another neural network in the set.

4. The method according to claim 2, wherein the set of neural networks comprises a sequence of neural networks including the selected neural network.

5. The method according to claim 1, wherein the sensor-originated data comprises at least one of:
image data representative of an image;
audio data representative of a sound; and
depth data representative of depth in an environment.

6. The method according to claim 5, wherein at least one of:
the image data comprises image feature data representative of at least one feature of the image; and
the audio data comprises audio feature data representative of at least one feature of the sound.

7. The method according to claim 1, wherein the operative condition of the computing device comprises an estimated energy usage to process the sensor-originated data using at least the selected one of the plurality of neural networks.

8. The method according to claim 1, wherein the operative condition of the computing device comprises an estimated latency of processing the sensor-originated data using at least the selected one of the plurality of neural networks.

9. The method according to claim 8, wherein the selecting is based on an indication that a value representative of the estimated latency has a predetermined relationship with a comparative latency value.

10. The method according to claim 1, wherein the at least one operative condition of the computing device comprises an availability of at least one system resource of the computing device.

11. The method according to claim 10, wherein the availability of the at least one system resource of the computing device comprises at least one of:
a state of charge of an electric battery configured to power the computing device;
an amount of available storage accessible by the computing device;
an amount of processor usage available to the computing device;
an amount of energy usage available to the computing device; and
an amount of bandwidth available to at least one processor configured to implement at least one of the first and second neural networks.

12. The method according to claim 1, wherein the at least one operative condition of the computing device comprises an availability of one or more given data types.

13. The method according to claim 2, wherein the at least one operative condition of the computing device comprises an indication that the set of neural networks can be utilized based on an availability of one or more given data types required by the set of neural networks.

14. The method according to claim 1, wherein the first neural network is the selected neural network, the method comprising:
processing the sensor-originated data using at least the first neural network;
obtaining an indication that the at least one data type not included in the first set is available for the processing; and
based on the indication, switching subsequent processing of sensor-originated data to using at least the second neural network.

15. A computing device comprising:
at least one processor;
storage accessible by the at least one processor, the storage configured to store sensor-originated data representative of one or more physical quantities measured by one or more sensors;
wherein the at least one processor is configured to implement a plurality of neural networks including a first neural network and a second neural network configured to generate output data of the same type,
wherein the first neural network is configured to receive a first set of input data types and the second neural network is configured to receive a second set of input data types, the second set including at least one data type not included in the first set; and
a controller configured to:
select between the plurality of neural networks on the basis of at least one current operative condition of the computing device; and
process the sensor-originated data using at least the selected neural network.

16. The computing device according to claim 15, wherein the controller is configured to process the sensor-originated data using a set of neural networks comprising the selected neural network.

17. The computing device according to claim 16, wherein the set of neural networks comprises a sequence of neural networks including the selected neural network.

18. The computing device according to claim 15, wherein the operative condition of the computing device comprises an estimated energy usage to process the sensor-originated data using at least the selected one of the plurality of neural networks.

19. The computing device according to claim 18, wherein the controller is configured to select based on an indication that a value representative of the estimated energy usage has a predetermined relationship with a comparative energy usage value.

20. The computing device according to claim 16, wherein:
the operative condition of the computing device comprises an estimated energy usage to process the sensor-originated data using the set of neural networks comprising the selected neural network; and
the controller is configured to select based on an indication that a value representative of the estimated energy usage has a predetermined relationship with a comparative energy usage value representative of an estimated energy usage to process the sensor-originated data using a different set of neural networks.
